(19) United States
(12) Patent Application Publication
(10) Pub. No.: US 2008/0257939 A1
(43) Pub. Date: Oct. 23, 2008

(54) X-RAY TUBE WITH GAP CONTROLLED BRAZE

(76) Inventors: Edward Emaci, Milwaukee, WI (US); Kent Shue, Kansas City, MO (US)

Correspondence Address: RAMIREZ & SMITH, PO BOX 341179, AUSTIN, TX, 78734, US

(21) Appl. No.: 11/737,111

(22) Filed: Apr. 18, 2007

(51) Int. Cl. H01J 35/04; B23K 1/00

(52) U.S. Cl. 228/177; 378/121

(57) ABSTRACT

A method is disclosed for brazing components in a structure using a gap setting surface and brazing foil as brazing filler between the parts in order to form uniform joints having optimal dimensions, shape and strength. The components are assembled in an unconstrained stack, and a controlled load is applied to the top of the stack. The stack is then heated to a temperature at which the brazing foil melts and reacts with the components to form the joints. The stack is cooled resulting in a brazed structure having the desired dimension.

### FIELD OF THE INVENTION

This invention relates generally to X-ray tube for high voltage applications, and more particularly to a method of brazing uniform structures using a brazing foil.

### BACKGROUND OF THE INVENTION

X-ray systems are generally utilized in various applications for imaging in the medical and non-medical fields. For example, X-ray systems, such as radiographic systems, computed tomography (CT) systems, and tomosynthesis systems, are used to create internal images or views of a patient based on the attenuation of X-ray beams passing through the patient. Based on the X-ray beams, a profile of the patient is created. Alternatively, X-ray systems may also be utilized in non-medical applications, such as detecting minute flaws in equipment or structures and/or scanning baggage at airports. Typically, the X-ray system includes an X-ray tube that is utilized as the source of X-ray beams directed to a detector or film. The X-ray tube includes a cathode assembly and an anode assembly, which may be housed inside an evacuated tube. The X-ray system may operate at high voltages and temperatures, which affect the life expectancy of the X-ray tube.

Because of the voltages and temperatures involved, various problems may occur that cause the X-ray tube to fail. The failures may include electrical stresses, such as high voltage instabilities, surface flashovers, and other insulating failures that reduce the life expectancy of the X-ray tube. That is, the insulator of the X-ray tube may fail because of the electrical stresses. The failures may also include high voltage breakdown of the insulating material due to the insulating material getting too hot because heat transfer from hot surfaces is not properly controlled.

Brazing is a process for joining metal parts as well as metal-to-ceramic parts, often of dissimilar composition, to each other. Typically, a brazing filler metal that has a melting point lower than that of the base material parts to be joined is interposed between the parts to form an assembly. The assembly is then heated to a temperature sufficient to melt the brazing filler metal. Upon cooling, a strong joint is formed.

The applied pressure brazing techniques commonly used to braze components together are unable to produce a reliable braze. Common problems are misalignment of brazed parts, braze joint thickness not being uniform and predictable, voids or holes forming in the braze part of the assembly, and overflow of braze material into undesirable regions of the assembly due to sensitivity to need for symmetric load application.

For the reasons stated above, and for other reasons stated below which will become apparent to those skilled in the art upon reading and understanding the present specification, there is a need in the art for a braze joint that has uniform thickness. In particular, there is a need for a new technique to overcome the poor braze joint control methods of today, which can lead to thermal stresses and thermal runaway conditions causing X-ray tubes to fail in electrical or mechanical manner, in X-ray tubes from mal-formed brazes.

### BRIEF DESCRIPTION OF THE INVENTION

The above-mentioned shortcomings, disadvantages and problems are addressed herein, which will be understood by reading and studying the following specification.

This invention is embodied in a brazing method comprising the steps of interposing an interlayer in foil form between components to be joined, providing a gap setting surface, assembling the components in a stack consisting of gap setting surface and the components separated by said interlayer foil, applying a controlled load on the top of the stack, heating the assembly under suitable conditions to a temperature at which the interlayer melts and reacts with the components, and cooling the assembly to produce a structure with uniform joints having substantially uniform dimensions, uniform layer of braze material for thermal conduction, and substantially uniform strength.

In another aspect, the present invention provides an X-ray tube. The X-ray tube includes an anode assembly configured to emit X-ray beams and a cathode assembly configured to emit electrons towards the anode assembly. A gap setting surface positioned between the cathode cup electrodes and an insulator controls the distance between the two components.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a cross sectional view of an imaging system having an imaging tube utilizing gap controlled brazing according to an embodiment;

FIG. 2 is a close-up perspective view of a cathode cup assembly according to an embodiment;

FIG. 3 is a representation of a brazed cathode cup assembly, insulator, and extender arm according to an embodiment;

FIG. 4 is a diagram of braze foil and gap setting surface for gap controlled braze according to an embodiment; (where is the gap setting surface?)

FIG. 5 is a diagram of an assembled braze foil, gap setting surface, and components for gap controlled braze according to an embodiment; (where is the braze setting surface)

FIG. 6 is a diagram of brazed components according to an embodiment; (where is the braze setting surface)

FIG. 7 is a flowchart of a method for brazing an insulator and a cathode post according to an embodiment;

FIG. 8 is a flowchart for selecting components, interlayer foil, and gap setting surface for brazing components according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

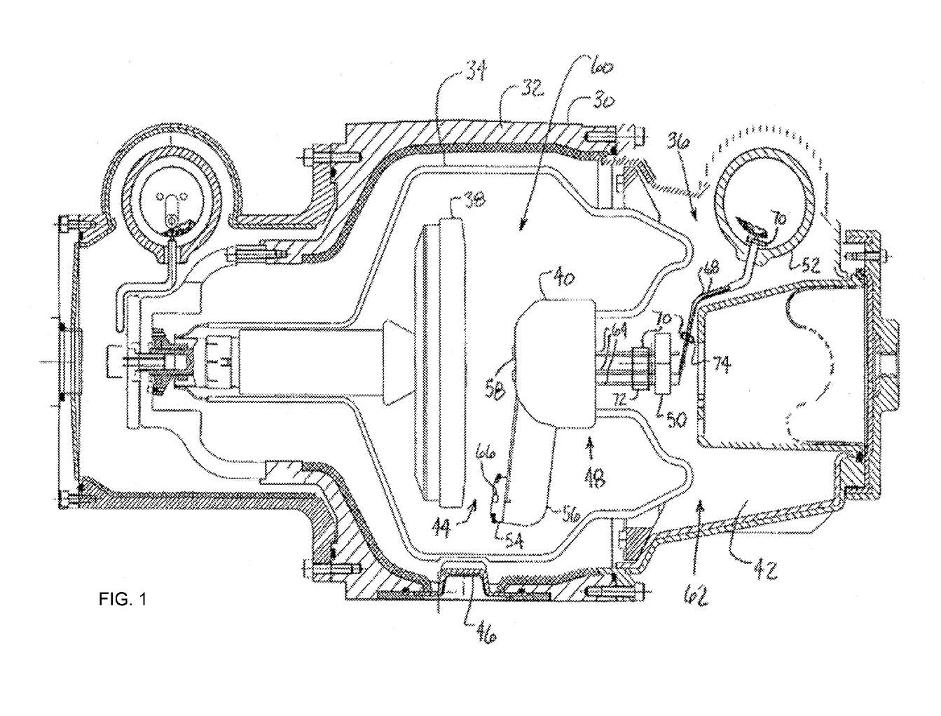

FIG. 1 is a cross-sectional view of an imaging tube 30 in accordance with an embodiment of the present invention is shown. The imaging tube 30 includes an exterior housing 32 having an insert 34 and a cathode circuit 36 contained therein. The insert 34 may be formed from glass and contains a rotating anode 38 and a cathode 40. The insert 34 is surrounded by the oil 42, which is circulated around the insert 34 and cooled via a pump and a heat exchanger (both of which are not shown). Electrons pass from the cathode cup 54 to the rotating anode 38 across a vacuum gap 44 where they impinge on the anode 38 and produce X-rays. The X-rays then pass through a window 46 in the housing 32 for scanning purposes.

The cathode circuit 36 includes a cathode assembly 48, a cathode receptacle 52, and a cathode driving circuit (not shown). The cathode assembly 48 includes a cathode cup 54 that is located within the insert 34 whereas the cathode terminal board 50 and the receptacle 52 are located outside of the insert 34. The receptacle 52 is coupled to a high voltage generator and filament drive circuit (both of which are not shown). The cathode cup 54 is coupled to an arm 56, which extends from a base or shell 58. The shell 58 separates a vacuum cavity 60 of the insert 34 from an oil cavity 62 that surrounds the insert 34. High voltage leads 64 extend from one or more filaments 66 (only one is shown) in the cathode cup 54 through the arm 56 and the shell 58 to the terminal board 50. The terminal board 50 is coupled to the receptacle 52 via the high voltage connections 68.

Power is received by the filaments 66 from the receptacle 52 and under control of the driving circuit. The power is supplied from the receptacle 52 to the terminal board 50 via the high voltage connections 68. The power is then supplied from the terminal board 50 to the filaments 66 via the high voltage leads 64. Besides holding HV leads in place, the terminal board 50 may also be utilized to offer additional bleeding resistance for the filaments 66, when temporary over-voltage occurs.

The cathode circuit 36 also includes multiple voltage-clamping devices 70. The clamping devices 70 may be coupled in parallel with and are substantially higher in resistance than the filaments 66. As such, the voltage clamping devices 70 do not affect voltage regulation of the cathode circuit 36 and performance of the driving circuit. The voltage-clamping devices 70 include a first clamping device 72, a second clamping device 74, and a third clamping device 76. The first clamping device 72 is coupled to the leads 64.

The second clamping device 74 is coupled to the connections 68 between the terminal board 50 and the receptacle 52. The third clamping device 76 is coupled to the HV connections 68 within the receptacle 52. The clamping devices 70 have a predetermined resistance and prevent overvoltage transients from occurring between the leads 64 and the HV connections 68. The clamping devices 70 perform as insulators and as voltage limiters.

When voltage potential between high voltage elements, such as between the leads 64 and the HV connections 68, is below a predetermined voltage level the clamping devices 70 perform as insulators and isolate the elements 64 and 68 from each other. The clamping devices 70 prevent the flow of current between the high voltage elements 64 and 68. When the voltage between the high voltage elements 64 or 68 is greater than or equal to the predetermined voltage level the clamping devices 70 allow the flow of current between the high voltage elements 64 or 68. Thus, the clamping devices 70 prevent voltage potential between the high voltage elements 64 or 68 from exceeding the predetermined voltage level.

The clamping devices 70 may be of various types, styles, sizes, shapes, and may be formed of various materials. The clamping devices 70 may be in the form of varistors, feed through varistors, resistive jumpers, and bleeding resistors, and may be formed of a resistive material, a resistive epoxy, and a semi-conductor epoxy. The clamping devices 70 may be in the form of a terminal board formed of resistive material or may be in some other form known in the art. The clamping devices 70 may, for example, be annular or disk like in shape, as shown. In addition, any number of clamping devices 70 may be used throughout the imaging tube 30.

The clamping devices 70 may be coupled between any high voltage elements including between cathode filaments, a cathode grid, and a cathode common, such as filaments 66, cathode cup 54, and return lines of the filaments. The clamping devices 70 may be voltage-clamping devices or may perform as current limiting devices. Several examples of clamping devices are described below. The clamping devices 70 may be formed of oxide zinc, silicone carbide, some other material known in the art, or a combination thereof. The use of varistors limits high frequency high voltage transients due to quick response time of the varistors.

Although the clamping devices described above and in the following figures are shown in particular locations, these locations are for example purposes only. The clamping devices may be located elsewhere.

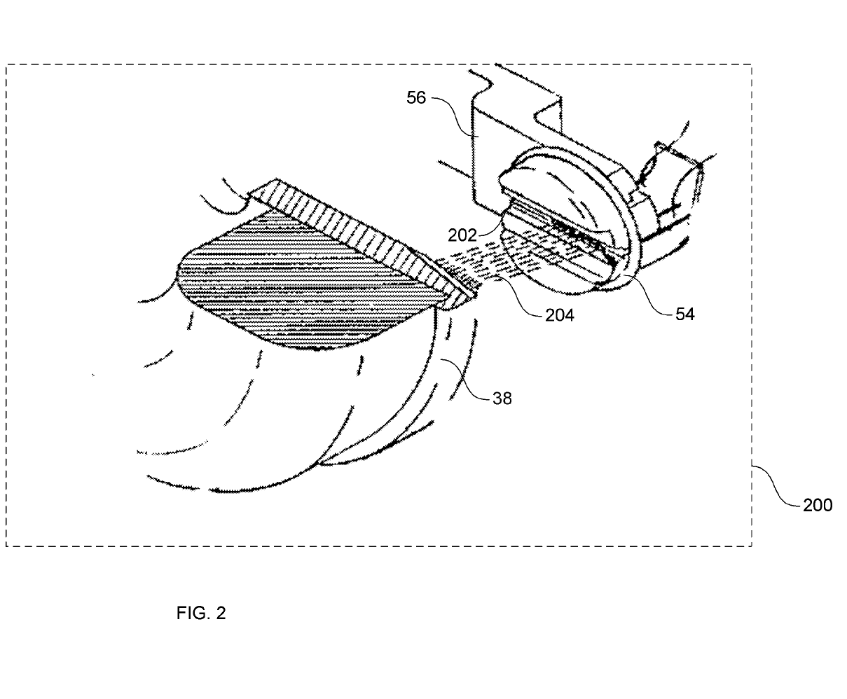

FIG. 2 is a close-up perspective sectional view 200 of a cathode cup assembly for an imaging tube, such as the imaging tube 30, in accordance with another embodiment of the present invention are shown.

The cathode cup assembly 54 includes the cathode cup 54 having the filament 202. The filament 202 has a large focal spot end and a common end 206. Each of the ends 206 are coupled to a pair of high voltage extensions that extend through a pair of feed through insulators. The feed through insulators are coupled to the cup 54 via washers. The washers are brazed to the cup 54.

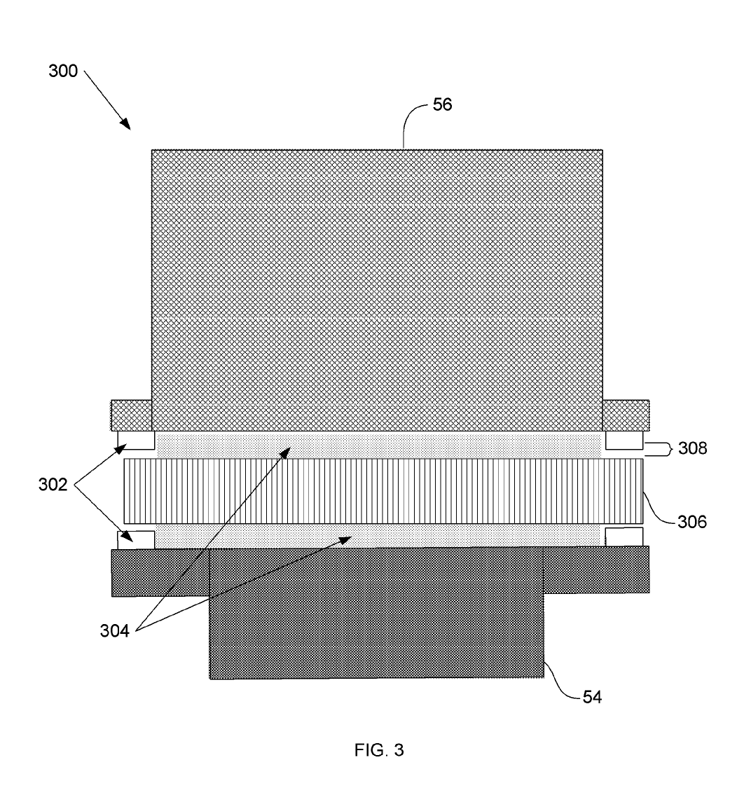

FIG. 3 is representation of a gap controlled braze 300 in accordance to an embodiment. The gap controlled braze solves the need in the art for components having braze with uniform thickness. The cup assembly 54 is brazed to insulator (ceramic) 306. The insulator 306 in turn is brazed to extender 56. The thickness or gap between the components is governed by the gap setting surface 302. The braze foil 304 after heating and cooling forms a bond between the components. The initial length of the braze foil 304 is longer then the length of the of the gap setting surface 302. Before a controlled force or controlled load is applied to the components there is a distance 308 between the components that is proportional to the difference in length between the gap setting surface 302 and the length of the braze foil 304. A controlled force will cause the distance 308 to shorten until the components (56 and 306, or 54 and 306) are pushing against each other or in intimate contact with each other. During the controlled loading and the heating process the excessive metal is partially expelled out of the brazed gaps forming fillets with large cross-sections and of an advantageous form, thus resulting in high strength joints. The overall dimensions of structures assembled from the components are constant regardless of variations in thickness of the foil 304 used and component (54, 56, and 306) dimensions because they are now functions of the gap setting surface 302 and the controlled load.

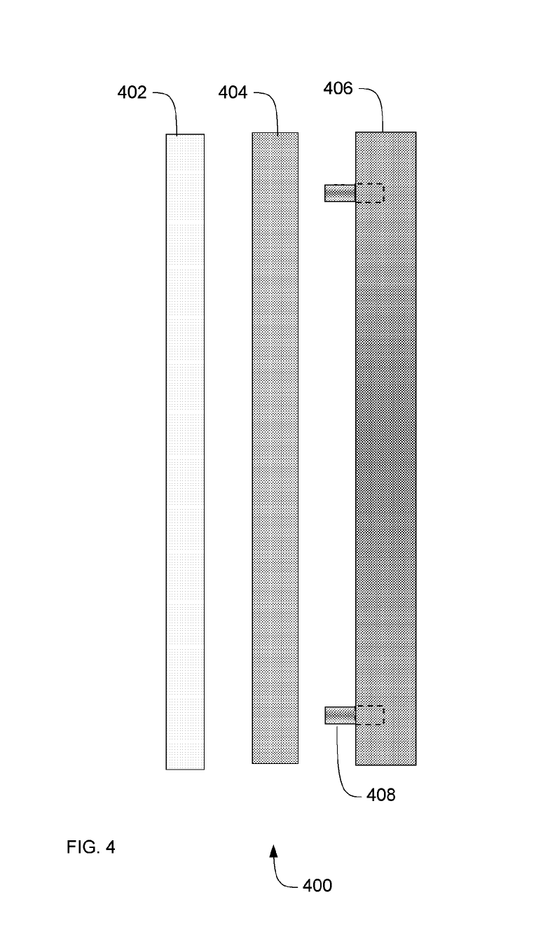

FIG. 4 shows the components for gap controlled braze 400 in accordance to an embodiment. First components 402, a gap setting surface 408, braze foil 408, and a second surface 406. The first component 402 can be any metal or material that needs to be permanently attached to another metal or material. The first component 402 in the preferred embodiment is a cathode post, cathode extender, or ceramic material. The gap setting surface 408 is one or more post that can be distribute over the first components so as to facilitate a uniform braze. These posts 408 can be separately attached rested on a destination surface like component 402, or machine so as to be protrusions extending out of the first component. Other materials could be used as the gap setting surface in place of pins, such as a piece of wire. The braze foil 402 can have any arbitrary thickness, and it can be chemically machined into a shape such as shown, to match the geometry of a cathode post or any other shape. As a general rule the thickness of the braze foil 402 should be greater than desired final thickness of the braze between the components. The second component 406 can be any metal or material that needs to be permanently attached to another metal or material. The second component 406 in the preferred embodiment is a ceramic surface, a cathode post, or a cathode extender.

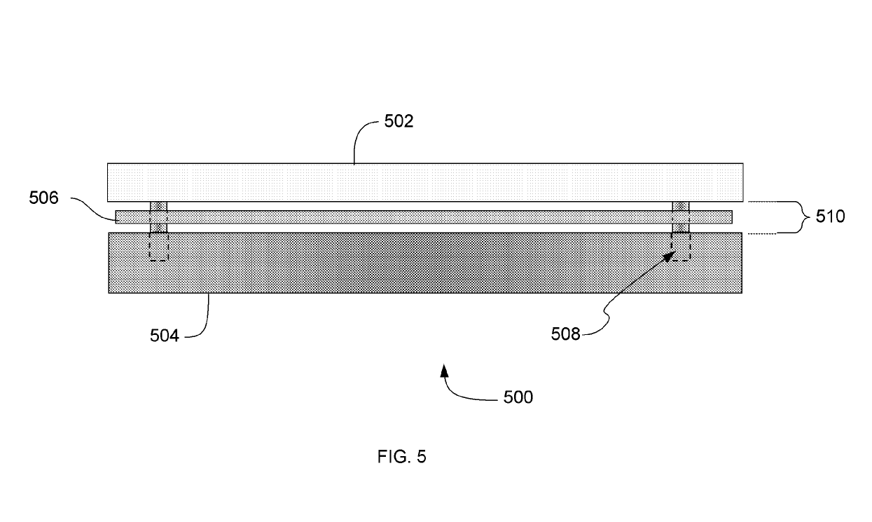

FIG. 5 is a representation of assembled components 502 and 504, gap setting surface 508, and braze foil 506. The gap between the components 502, 506 is set and determined by the length of the gap setting surface 508. The braze foil 506 needs to be thicker then the desired final thickness, which will be set by the pins 508. Next the part to be attached is set on top of braze foil 506 and clamped with sufficient pressure to hold the part from moving. When the part is heated in the furnace the braze foil will melt and the part will sink down on to the pins. The braze foil 506 may include silver, silver-copper alloy or gold-copper alloy. A non-buckling load is applied to the assembly by placing a fixed amount of weight on the top of the stack or by applying one or more clamp. The load should not cause the stack to collapse at the brazing temperature when the assembly is placed in a furnace and is heated to at least the melting temperature of the braze foil.

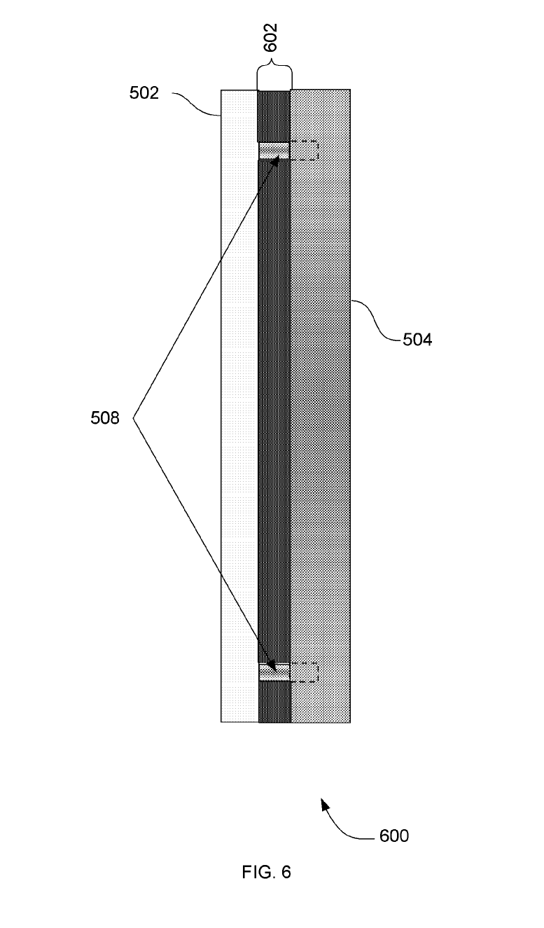

FIG. 6 is a representation of assembled components 502 and 504 after the brazing process. The assembly is placed in a furnace and is heated to at least the melting temperature of the braze foil 506 and the assembly 600 is cooled. Under these conditions, the brazing foil 506 melts and fills the gap 602 between components (502, 504) being brazed. Simultaneously, and most specifically, the gap setting surface 508 maintains the gap at a particular dimension. Excessive molten metal is partially expelled out of the brazed gap 602 forming fillets. The overall dimension 602 of the braze structure 600 is controlled by the gap setting surface 508 regardless of variations in thickness of the braze foil 510 used and the uniformity of the components 602 and 604. Since the dimension of the gap is substantially uniform each joint between the components has optimum geometry with substantially uniform dimensions and substantially uniform strength.

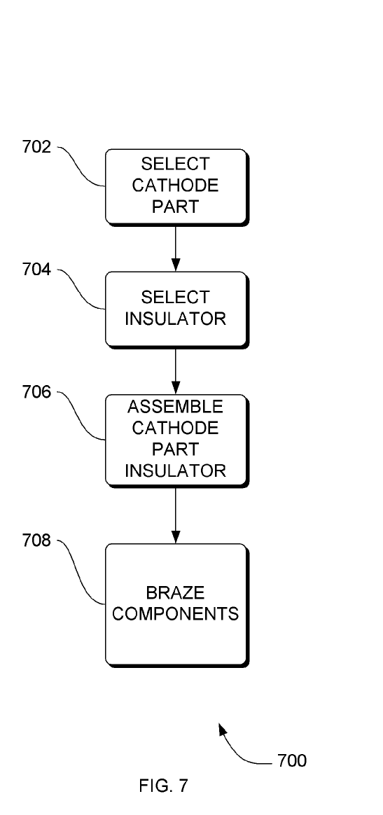

FIG. 7 is a flowchart of a method 700 to control the gap of a braze between components in a an x-ray tube according to an embodiment. Method 700 solves the need in the art for a braze between two parts having a uniform thickness of base joint.

Method 700 includes selecting a cathode part 702, selecting an insulator 704, assembling the cathode part and insulator, and brazing the cathode part with insulator. It should be noted that the selecting of the cathode part 702 and insulator 704 can be done sequentially or in parallel since these actions are independent of each other.

Method 700 begins with action 702. In action 702 the cathode part is selected. The cathode part can be a cathode post, cathode extender, or any other part of a cathode assembly.

In action 704, an insulator is selected. The insulator may include various aspects and structures that are utilized to provide support for the cathode part and the gap setting surface or pins 70. The insulator is made of electrically insulated material, such as ceramic.

In action 706, the cathode part selected in action 702 and the selected insulator 704 are assembled. The assembling of these parts is more than mere stacking of cathode part and the insulator, the gap setting surface 408 is also included to assure a desired gap, the braze foil 404 is included to braze the parts together, and the controlled load are all combined to acquire a controlled braze.

In action 708, the braze process is performed on the assembled components. Once the brazing material is applied, the assembled component 400 is heated to just over the melting point of the brazing material. The heating permits the assembled component 400 to become sufficiently coated or wetted by the brazing material. Preferably, the assembled component 400 is heated over the melting point of the braze foil 404, more preferably to about 7% over the melting point. The temperature, however, should be much lower than the melting points of the cathode part and the insulator. Thus, heating the assembled component to slightly over melting point of the braze foil 404 will melt only the brazing alloy and not the cathode part or insulator. After the heating assembly 400 is cooled. Since the gap control surface creates a uniform plane each joint between the components has optimum geometry with uniform dimensions and substantially uniform strength.

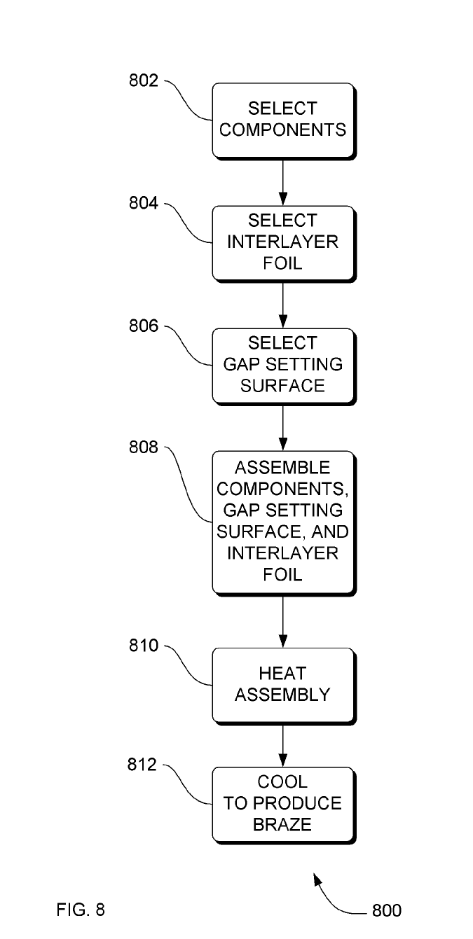

FIG. 8 is a flowchart of a method 800 to control the gap of a braze between components according to an embodiment. Method 800 solves the need in the art for a braze that has uniform thickness and is insensitive to load magnitude and symmetry application.

Method 800 includes action for selecting components 802, selecting an interlayer foil 804, selecting a gap setting surface 806, assembling the items selected in actions 802 through 806, applying heat to the assembly 810, and cooling the heated assembly 812.

Method 800 begins with action 802 of selecting components that need to be brazed together. The components can be any metal or material that needs to be permanently attached to another metal or material. In imaging the components are a combination of cathode cup, cathode extender, ceramic material, plastic material, insulator, metal alloy, and metal composite. In action 804, the interlayer foil or braze foil is selected. The braze foil (304, 404, 506) can have any arbitrary thickness, and it can be chemically machined or laser cut into a shape such as shown, to match the geometry of a cathode cup or any other shape. In action 806, the gap setting surface is selected. In actions 808 through 812 the components are assembled, heated, and cooled to produce braze components. Once the brazing material is applied and the components are secured in place, the assembly is heated to just over the melting point of the brazing material. The heating permits the liquification of braze material (304, 404) and bonding with component parts.

### CONCLUSION

A technique for brazing components for an x-ray tube is described. A technical effect of the technique is that the joint between the components has optimum geometry with substantially uniform dimensions and substantially uniform strength. Although specific embodiments are illustrated and described herein, it will be appreciated by those of ordinary skill in the art that any arrangement which is calculated to achieve the same purpose may be substituted for the specific embodiments shown. This application is intended to cover any adaptations or variations.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future heating devices, different braze foils, and new alloys and metals.

We claim:

1. A method for brazing components, the method comprising:
providing an interlayer in foil form;
providing a gap setting surface;
assembling the components in a stack consisting of gap setting surface and the components separated by said interlayer foil, whereby the stack is unconstrained from movement in the vertical direction and constrained from movement in the lateral direction; and
applying a controlled load on top of said stack acting in a vertical direction.

2. The method of claim 1, the method further comprising:
heating said stack to a temperature at which said interlayer melts and reacts with the components; and
cooling said stack to produce the brazed components, whereby each joint between the components has optimum geometry with substantially uniform dimensions and substantially uniform strength.

3. The method of claim 1, wherein the interlayer in foil form before application of the controlled load is taller than the gap setting surface.

4. The method of claim 1, wherein the gap setting surface is one or more pin, or one or more wire.

5. The method of claim 1, wherein the gap setting surface is one or more pin pressed into one of the components, or one or more raised surface on one of the components.

6. The method of claim 5, wherein the length of the pin or wire is set to the substantially uniform dimension.

7. The method of claim 1, wherein the controlled load on top of the stack acting in a vertical direction does not exceed a load amount that will cause the gap setting surface to buckle.

8. The method of claim 1, wherein the components and the gap setting surface have a higher melting point than the interlayer foil.

9. The method of claim 1, wherein one of the components is a cathode cup or cathode extender in a cathode assembly in an X-ray tube.

10. The method of claim 1, wherein one of the components is an insulator in a cathode assembly in an X-ray tube.

11. The method of claim 10, wherein the insulator comprises a ceramic material.

12. An X-ray tube comprising:
an anode assembly configured to emit X-ray beams; and
a cathode assembly configured to emit electrons towards the anode assembly, wherein the cathode assembly comprises:
an insulator comprising a top surface and a bottom surface;
a cathode element comprising a top surface and a bottom surface; and
a gap setting surface positioned between the cathode element and the insulator, whereby the distance between the cathode element and the insulator is set by the gap setting surface.

13. The X-ray tube of claim 12, wherein the cathode element of the cathode assembly is one or more cathode extender, cathode cup.

14. The X-ray tube of claim 12, the X-ray tube further comprising:
an interlayer in foil form positioned between the cathode element and the insulator, whereby when a melting heat is applied the interlayer melts and reacts with the cathode element and the insulator.

15. The X-ray tube of claim 14, wherein the interlayer in foil form before application of the controlled load is taller than the gap setting surface.

16. The X-ray tube of claim 14, wherein the insulator of the cathode assembly comprises a ceramic material.

17. The X-ray tube of claim 14, wherein the gap setting surface of the cathode assembly is one or more pin or one or more wire.

18. The X-ray tube of claim 14, wherein the gap setting surface of the cathode assembly is one or more pin pressed into the cathode element or raised surface on the cathode element.

19. The X-ray tube of claim 14, wherein the reaction brazes the cathode element and the insulator.

20. The X-ray tube of claim 19, wherein each joint between the cathode element and the insulator has optimum geometry with substantially uniform dimensions and substantially uniform strength.
